(19) United States
(12) Patent Application Publication
(10) Pub. No.: US 2026/0064735 A1
(43) Pub. Date: Mar. 5, 2026

(54) DATA PROCESSING METHOD, APPARATUS, MEDIUM, DEVICE AND COMPUTER PROGRAM PRODUCT

(71) Applicant: Beijing Youzhuju Network Technology Co., Ltd., Beijing (CN)

(72) Inventors: Shaoyu ZHANG, Beijing (CN); Yongfu MA, Beijing (CN)

(21) Appl. No.: 19/299,990

(22) Filed: Aug. 14, 2025

(30) Foreign Application Priority Data
Aug. 29, 2024 (CN) 202411206336.3

(51) Int. Cl. G06F 16/3329; G06N 5/02

(52) U.S. Cl. CPC G06F 16/33295; G06N 5/02

(57) ABSTRACT

The present disclosure relates to a data processing method, an apparatus, a medium, a device and a computer program product. The method includes: receiving retrieval data; matching the retrieval data with structured data in a knowledge database to obtain candidate question data and candidate answer data, where knowledge in the knowledge database is represented by the structured data, and each piece of the structured data includes one piece of answer data and at least one piece of question data corresponding to the answer data; and generating a target retrieval result corresponding to the retrieval data according to the candidate question data and the candidate answer data.

### CROSS-REFERENCE TO RELATED APPLICATION

This application claims the priority to and benefits of the Chinese Patent Application, No. 202411206336.3, which was filed on Aug. 29, 2024. The aforementioned patent application is hereby incorporated by reference in its entirety.

### TECHNICAL FIELD

The present disclosure relates to the field of computer technology, and in particular, to a data processing method, an apparatus, a medium, a device and a computer program product.

### BACKGROUND

With the development of computer technology, users may retrieve required knowledge by interacting with a large language model. In the related art, related knowledge is retrieved under a RAG (Retrieval Augmented Generation) architecture, and the retrieved knowledge is incorporated into the large language model, so that a reasonable answer can be given by referring to the corresponding knowledge and combining the input of the user. The efficiency and accuracy of recalling knowledge will seriously affect the efficiency and accuracy of the model answer.

### SUMMARY

The Summary part is provided to introduce concepts briefly, which will be described in detail in the following Detailed Description of Embodiments part. The Summary part is not intended to identify key features or necessary features of the claimed technical solution, nor is it intended to be used to limit the scope of the claimed technical solution.

In a first aspect, the present disclosure provides a data processing method, the method includes: receiving retrieval data; matching the retrieval data with structured data in a knowledge database to obtain candidate question data and candidate answer data, where knowledge in the knowledge database is represented by the structured data, and each piece of the structured data includes one piece of answer data and at least one piece of question data corresponding to the answer data; and generating a target retrieval result corresponding to the retrieval data according to the candidate question data and the candidate answer data.

In a second aspect, the present disclosure provides a data processing apparatus, the apparatus includes: a receiving module, configured to receive retrieval data; a matching module, configured to match the retrieval data with structured data in a knowledge database to obtain candidate question data and candidate answer data, where knowledge in the knowledge database is represented by the structured data, and each piece of the structured data includes one piece of answer data and at least one piece of question data corresponding to the answer data; and a generating module, configured to generate a target retrieval result corresponding to the retrieval data according to the candidate question data and the candidate answer data.

In a third aspect, the present disclosure provides a computer-readable medium, on which a computer program is stored, and when the computer program is executed by a processing apparatus, the steps of the method according to the first aspect are implemented.

In a fourth aspect, the present disclosure provides an electronic device, including: a storage apparatus, on which a computer program is stored; and a processing apparatus, configured to execute the computer program in the storage apparatus to implement the steps of the method according to the first aspect.

In a fifth aspect, the present disclosure provides a computer program product, including a computer program, and when the computer program is executed by a processor, the steps of the method according to the first aspect are implemented.

In the above technical solution, the knowledge in the knowledge database is represented by the structured data, so that the corresponding knowledge can be obtained by matching the question in the process of knowledge retrieval, and the amount of data that needs to be matched is effectively reduced, thereby improving the data processing efficiency. In addition, the structured data includes the answer data and at least one piece of question data, so as to ensure the matching between the retrieval data and the question data, improve the accuracy of the matched question data, and at the same time, ensure the comprehensiveness of the matched question data to a certain extent, thereby ensuring the accuracy of the obtained candidate answer data. Therefore, the recall accuracy and efficiency of knowledge in the process of knowledge retrieval can be effectively improved, and effective data support is provided for subsequent data analysis based on the target retrieval result.

Other features and advantages of the present disclosure will be described in detail in the following detailed description part.

### BRIEF DESCRIPTION OF DRAWINGS

The above and other features, advantages and aspects of the embodiments of the present disclosure will become more apparent when taken in conjunction with the drawings and with reference to the following detailed description. Throughout the drawings, the same or similar reference numerals refer to the same or similar elements. It should be understood that the drawings are schematic and that the components and elements are not necessarily drawn to scale. In the drawings:

FIG. 1 is a flowchart of a data processing method provided based on an implementation of the present disclosure.

FIG. 2 is a schematic diagram of an interactive interface provided based on an implementation of the present disclosure.

FIG. 3 is a block diagram of a data processing apparatus provided based on an implementation of the present disclosure.

FIG. 4 shows a schematic structural diagram of an electronic device suitable for implementing the embodiments of the present disclosure.

### DETAILED DESCRIPTION

The embodiments of the present disclosure will be described in more detail below with reference to the drawings. Although some embodiments of the present disclosure are shown in the drawings, it should be understood that the present disclosure can be implemented in various forms, and should not be interpreted as limited to the embodiments set forth herein, on the contrary, these embodiments are provided for a more thorough and complete understanding of the present disclosure. It should be understood that the drawings and embodiments of the present disclosure are only used for exemplary purposes, and are not used to limit the protection scope of the present disclosure.

It should be understood that the various steps described in the method implementations of the present disclosure may be performed in a different order, and/or in parallel. In addition, the method implementations may include additional steps and/or omit to perform the illustrated steps. The scope of the present disclosure is not limited in this respect.

The term “include/comprise” and its variants as used herein are open-ended inclusions, that is, “include/comprise but not limited to”. The term “based on” is “at least partially based on”. The term “one embodiment” means “at least one embodiment”; the term “another embodiment” means “at least one other embodiment”; and the term “some embodiments” means “at least some embodiments”. Relevant definitions of other terms will be given in the following description.

It should be noted that concepts such as “first” and “second” mentioned in the present disclosure are only used to distinguish between different apparatuses, modules or units, and are not used to limit the order or interdependence of the functions performed by these apparatuses, modules or units.

It should be noted that the modifications of “one” and “a plurality of” mentioned in the present disclosure are illustrative rather than restrictive, and those skilled in the art should understand that unless the context clearly indicates otherwise, it should be understood as “one or more”.

The names of messages or information exchanged between a plurality of apparatuses in the implementations of the present disclosure are only used for illustrative purposes, and are not used to limit the scope of these messages or information.

It should be understood that before using the technical solution disclosed in the embodiments of the present disclosure, the user should be informed of the type, use scope, use scene, etc. of the personal information involved in the present disclosure and obtain the user's authorization in an appropriate manner according to relevant laws and regulations.

For example, in response to receiving an active request from the user, prompt information is sent to the user to explicitly prompt the user that the operation requested to be performed will require acquisition and use of the user's personal information. Therefore, the user can independently select whether to provide personal information to software or hardware such as an electronic device, an application, a server or a storage medium that performs the operation of the technical solution of the present disclosure according to the prompt information.

As an optional but non-limiting implementation, the manner of sending prompt information to the user in response to receiving the active request from the user may be, for example, a pop-up window, and the prompt information may be presented in the pop-up window in a text form. In addition, the pop-up window may also carry a selection control for the user to select “agree” or “disagree” to provide personal information to the electronic device.

It should be understood that the above process of notifying and obtaining the user's authorization is only illustrative and does not constitute a limitation to the implementations of the present disclosure, and other manners that meet relevant laws and regulations may also be applied to the implementations of the present disclosure.

At the same time, it should be understood that the data involved in the technical solution (including but not limited to the data itself, the acquisition or use of the data) should comply with the requirements of relevant laws, regulations and relevant provisions.

FIG. 1 is a flowchart of a data processing method provided based on an implementation of the present disclosure. As shown in FIG. 1, the method may include:

In Step 11, receive retrieval data. The retrieval data represents data input by a user for retrieval, for example, the retrieval data may be input text data, or input voice data, etc.

In Step 12, match the retrieval data with structured data in a knowledge database to obtain candidate question data and candidate answer data.

The knowledge in the knowledge database is represented by the structured data, so that the quality of the knowledge in the knowledge database can be effectively improved, so as to improve the retrieval efficiency of the knowledge. Accordingly, each piece of the structured data includes one piece of answer data and at least one piece of question data corresponding to the answer data. For example, each piece of knowledge is represented by one piece of structured data, the structured data includes answer data corresponding to the knowledge, and the structured data also includes at least one question for retrieving the knowledge. For example, for the answer data for explaining AI, the corresponding question data may include:

Question 1: What is AI? Question 2: What does AI stand for? Question 3: What can AI do?

That is, it means that when retrieving based on any of the above questions 1-3, the answer data may be fed back as the retrieval result.

Therefore, in this step, when retrieving from the knowledge database based on the retrieval data, there is no need to match the retrieval data with the corpus in the knowledge database, and the amount of data processing is effectively reduced by matching the question data, thereby improving the data retrieval efficiency.

In Step 13, generate a target retrieval result corresponding to the retrieval data according to the candidate question data and the candidate answer data.

As an example, the retrieved candidate question data and candidate answer data may be used as the target retrieval result. For example, the retrieved candidate question data and candidate answer data may be displayed to the user as the target retrieval result, and then the user may select a desired question from the candidate question data based on a retrieval requirement, and then display an answer corresponding to the selected question, so as to improve the efficiency of data retrieval.

In the above technical solution, the knowledge in the knowledge database is represented by the structured data, so that the corresponding knowledge can be obtained by matching the question in the process of knowledge retrieval, and the amount of data that needs to be matched is effectively reduced, thereby improving the data processing efficiency. In addition, the structured data includes the answer data and at least one piece of question data, so as to ensure the matching between the retrieval data and the question data, improve the accuracy of the matched question data, and at the same time, ensure the comprehensiveness of the matched question data to a certain extent, thereby ensuring the accuracy of the obtained candidate answer data. Therefore, the recall accuracy and efficiency of knowledge in the process of knowledge retrieval can be effectively improved, and effective data support is provided for subsequent data analysis based on the target retrieval result.

In a possible embodiment, the step in which the retrieval data is matched with the structured data in the knowledge database to obtain the candidate question data and the candidate answer data may include: preprocessing the retrieval data to obtain processed retrieval data.

The preprocessing may include synonym replacement, removal of non-text elements, text segmentation, filtering stop words, etc., which may be configured based on requirements of actual application scenarios. For example, stop words in the retrieval data may be deleted to normalize the text, in and then a vectorization representation corresponding to the standard text is generated and used as the processed retrieval data.

After that, the processed retrieval data is matched with the at least one piece of question data in the structured data, the matched question data is used as the candidate question data, and the answer data corresponding to the candidate question data is used as the candidate answer data.

As an example, vector calculation may be performed based on the vectorization representation corresponding to the processed retrieval data and the vectorization representation corresponding to the question data, respectively. When the meanings represented by two questions are similar, their representations in the vector space are similar. For example, the cosine similarity between two vectors may be determined as the matching degree, and the greater the similarity, the higher the matching degree. For example, it may be considered that the processed retrieval data matches the question data when it is determined that the similarity between the vectors is less than a preset threshold, so that the candidate question data matching the retrieval data can be quickly determined from the knowledge database. Further, the answer data corresponding to the candidate retrieval question may be used as the candidate answer data, so as to generate data for answering the retrieval data.

Therefore, through the above technical solution, when recalling the knowledge in the knowledge database, the retrieval data may be directly matched with the question data, so that the amount of data processing is effectively reduced, and the efficiency of data processing is improved. In addition, the recall rate of knowledge may be improved by symmetrically matching the question with the question, so as to provide comprehensive data support for determining the target retrieval result.

In a possible embodiment, the step in which the target retrieval result corresponding to the retrieval data is generated according to the candidate question data and the candidate answer data may include:

Obtaining a matching degree between each piece of the candidate question data and the retrieval data. The determining way of the matching degree has been described in detail above, and will not be repeated here.

After that, if there is a matching degree greater than a preset threshold, the candidate answer data corresponding to the candidate question data with the highest matching degree is determined as the target retrieval result.

The preset threshold may be set based on actual application scenarios, which is not limited in the present disclosure. If the matching degree between the retrieval data and one piece of question data is greater than the preset threshold, it may be considered that the retrieval data is consistent with the question data. Therefore, in this scenario, the candidate answer data corresponding to the candidate question data with the highest matching degree is determined as the target retrieval result, and thus, the best matching question may be determined therefrom, and the answer data in the knowledge database is directly used as the feedback of the retrieval data.

Therefore, by matching the retrieval data with the question data, on the one hand, the amount of data processing can be effectively reduced, and on the other hand, the accuracy and effectiveness of the retrieval recall data can be ensured. Moreover, after the matching question is determined, the answer data corresponding to the question may be directly used as the retrieval result, so that the accuracy and determination efficiency of the retrieval result can be effectively improved, the retrieval efficiency of the knowledge in the knowledge database can be improved, and the user can be responded in time, so as to improve the user experience.

In another possible embodiment, the step in which the target retrieval result corresponding to the retrieval data is generated according to the candidate question data and the candidate answer data may include:

Obtaining a matching degree between each piece of the candidate question data and the retrieval data. The determining way of the matching degree has been described in detail above.

If there is no matching degree greater than the preset threshold, the prompt text is constructed according to the candidate question data, the candidate answer data, and the retrieval data, so as to generate the target retrieval result based on the prompt text and the retrieval model.

If there is no matching degree greater than the preset threshold, it means that no question consistent with the retrieval data has been recalled in the knowledge database. In this scenario, it is difficult to ensure the consistency between the retrieval result and the retrieval data when the candidate answer data is directly used as the retrieval result for feedback. In this embodiment, data processing may be further performed in combination with the recalled candidate question data, the candidate answer data, and the retrieval data, so as to obtain the target retrieval result.

As an example, the prompt text may be constructed based on prompt engineering. For example, a template of the prompt text may be preset, and after the candidate question data, the candidate answer data, and the retrieval data are determined, the above data may be spliced based on the template to obtain the prompt text. For example, it may be to summarize an answer for answering the following question {retrieval data} by combining the following question and answer combinations {candidate question data 1, candidate answer data 1}, {candidate question data 2, candidate answer data 2}, etc., and then the above information may be spliced to corresponding positions in turn to obtain the prompt text.

After that, the prompt text may be inputted into the retrieval model, and the data in the prompt text is analyzed and summarized based on the retrieval model to obtain the target retrieval result. The retrieval model may be implemented based on a general large language model in the art, and in this step, the above prompt text may be inputted into the large language model for analysis based on the data analysis capability of the large language model, and the return result of the large language model is obtained and used as the target retrieval result.

Therefore, through the above technical solution, when determining the target retrieval result corresponding to the retrieval data, it may be determined based on the answer data corresponding to the question data recalled from the knowledge database, so that the efficiency of knowledge recall is effectively improved, and the comprehensiveness and integrity of the recalled knowledge are ensured, so as to ensure the accuracy of the target retrieval result.

In a possible embodiment, the determining way of the structured data in the knowledge database may include: obtaining corpus data corresponding to the knowledge.

The corpus data may be text content, or conversation records and processing work order records, etc., and may be knowledge obtained from the network, or business data knowledge obtained from a business system, such as record documents or communication records.

Processing the corpus data to obtain a processed text corresponding to the corpus data.

As an example, if the corpus data is a text type, the text corresponding to the corpus data may be used as the processed text. If the corpus data is not a text type, for example, the corpus data may be an audio and video type, the corresponding text obtained by performing speech recognition on the audio may be used as the processed text, or for example, the image may also be recognized in the video type, and the description information of the image is used as the processed text. The key frame in the video may be obtained by extracting the image in the video in advance through a key frame model, and then the text information in the key frame is extracted. The recognition of the key frame may be analyzed and extracted based on a general model or a large language model in the art, for example, it may be recognized by combining the similarity between image frames in the video, which is not limited in the present disclosure.

Therefore, through the above processing manner, the obtained corpus data may be converted into a text type representation.

After that, at least one piece of processed structured data corresponding to the processed text is generated based on the processed text, and the processed structured data includes one piece of processed answer data and at least one piece of processed question data corresponding to the processed answer data.

A prompt text may be constructed based on the processed text, and a large language model is invoked based on the prompt text to analyze the processed text through the large language model. For example, the following prompt text may be generated for invoking: please generate question and answer pair data based on the following input {processed text}, and the output format is {[question 1], [question 2], . . . ; [answer]}.

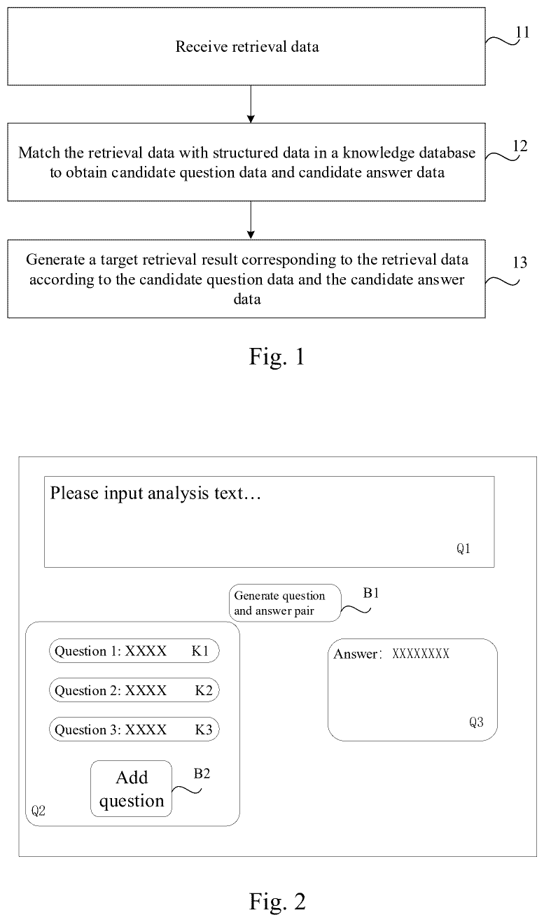

As an example, in this step, the processed text may be uploaded through a visual interface to construct the prompt text based on a prompt template to invoke the large language model, so as to obtain the processed structured data output by the large language model. As shown in the schematic diagram of the interactive interface in FIG. 2, the user may input the processed text into the document area Q1, and then click the generate button B1 to trigger generation of the structured data.

After that, the processed structured data is verified to determine the target structured data.

The analysis process of the large language model has a certain randomness, so in this step, the processed structured data may be verified to improve the accuracy and high quality of the generated question and answer pair.

As an example, the step in which the structured data in the knowledge database is determined based on the processed structured data may include:

Determining, for each piece of the processed structured data, whether the processed question data and the processed answer data in the processed structured data match.

If there is only one piece of question data in the processed structured data, the prompt text may be constructed by using the question data and the answer data therein, for example, please analyze whether the following question {question data} and answer {answer data} match, and then the large language model may be invoked to perform data analysis based on the prompt text, so as to determine whether the answer is used to answer the question. If there are a plurality of pieces of question data in the processed structured data, the prompt text may be constructed for each question separately in the same manner for subsequent matching.

Verifying the processed structured data based on the matched result and a verification condition to obtain the target structured data.

The verification condition includes: if the processed question data and the processed answer data do not match, deleting the processed question data; and if there is no processed question data matching the processed answer data in the processed structured data, deleting the processed structured data.

A plurality of questions may correspond to the processed answer data, and when the one piece of processed question data does not match the processed answer data, it means that the processed answer data cannot be used to answer the processed question data, and the processed question data may be deleted at this time. It may also be determined whether the processed answer data may match other question data corresponding to the processed answer data, and if there is matching processed question data, the processed question data may be retained. For example, for the structured data D1, which includes the question A11, the question A12, the question A13, and the answer A1; and for the structured data D2, which includes the question A21, the question A22, the question A23, and the answer A2.

If it is determined that the question A11 does not match the answer A1 through the above steps, the question A11 is deleted, if the question A12 matches the answer A1, the question A12 is retained, and if the question A13 matches the answer A1, the question A13 is retained, and the obtained target structured data may be represented as D1 {A12, A13; A1}.

After the matching is completed in turn, if there is no processed question data matching the processed answer data in the processed structured data, it means that the processed answer data cannot be used to answer any question in the processed structured data, that is, it is considered that the question and answer pair in the processed structured data is unreasonable, and the processed structured data may be directly deleted at this time.

For example, for the structured data D2, the question A21, the question A22, and the question A23 do not match the answer A2, and the structured data D2 may be directly deleted at this time. Thus, the structured data obtained after the verification processing is used as the target structured data.

Therefore, through the above technical solution, the structured data may be automatically verified, which saves the workload of manual analysis and ensures the accuracy of the target structured data to a certain extent, and provides data support for subsequent effective retrieval and recall of knowledge.

As another example, the step in which the processed structured data is verified to determine the target structured data may include: displaying the processed structured data.

As shown in FIG. 2, the generated structured data may be displayed in the interactive interface, for example, the processed question data is displayed in the display area Q2, and the processed answer data is displayed in Q3, so that the user can browse.

After that, in response to receiving an update operation of the user on the processed question data in the processed structured data, the processed question data in the processed structured data is updated with the question data obtained after the update operation, to obtain the target structured data.

For example, the user may add new question data by clicking the add control B2, for example, the generated processed question data displayed in the input boxes K1-K3, and the user clicks B2 to display the input box K4, so that the user may input a new question. For another example, the user may select the input box in K1-K3 to realize the update operation on the generated question data, where the update operation may include an addition, modification and deletion operation to the question data. After confirmation by the user, the user can click submit, and the questions in the respective input boxes may be used as the processed question data, to replace the processed question data in the processed structured data, and the processed question data and the processed answer data are used as the target structured data.

Therefore, through the above technical solution, the user may be supported to modify the question data, so as to realize the verification processing of the structured data, improve the accuracy of the generated target structured data, and ensure the accuracy and effectiveness of the subsequent knowledge recall by improving the accuracy of the question data.

After the target structured data is determined, the structured data in the knowledge database may be updated based on the target structured data.

As an example, the target structured data may be directly stored in the knowledge database. In an actual scenario, some knowledge may change with time, so that there may be conflicts between answer data in the structured data generated at different times. As another example, the step in which the structured data in the knowledge database is updated based on the target structured data includes: determining whether there is second question data matching first question data in the target structured data in the structured data stored in the knowledge database.

The first question data and the second question data may be vectorized, and then the similarity calculation is performed based on the vectors corresponding to the first question data and the second question data, respectively. If the similarity exceeds a preset threshold, it may be determined that the first question data matches the second question data, and in this scenario, it is considered that the first question data and the second question data represent the same question.

If there is no second question data, the target structured data is stored in the knowledge database.

If there is no second question data, it means that there is no same question in the target structured data in the knowledge database, which means that there is no conflict between the target structured data and the data already stored in the knowledge database, and the target structured data may be directly stored.

If there is the second question data, updated answer data corresponding to the second question data is generated based on first answer data in the target structured data and second answer data corresponding to the second question data.

If there is second question data, it means that there is the same question in the target structured data in the knowledge database. At this time, there may be a conflict between the target structured data and the data already stored in the knowledge database, so it is necessary to update the data already stored in the database.

As an example, the second answer data may be replaced with the first answer data as the updated answer data, that is, the latest answer is used to replace the previously stored answer, so as to ensure the timeliness of the answer. As another example, the prompt text may be constructed based on the first answer data in the target structured data and the second answer data corresponding to the second question data, and the large language model is invoked based on the prompt text to perform comprehensive analysis, so as to generate comprehensive answer data by combining the first answer data and the second answer data, to obtain the updated answer data. As another example, the prompt text may also include time information generated for each piece of answer data, so that the large language model can process in combination with the time information.

Updated target structured data is generated according to the first question data, the second question data, and the updated answer data, and the updated target structured data is stored in the knowledge database.

As an example, the updated answer data may be used as the answer data, and the first question data and the second question data are used as the question data, respectively, to generate the target structured data and store it in the knowledge database, and the updated target structured data is generated based on the generated target structured data and the data already stored in the database.

Therefore, through the above technical solution, the corpus data corresponding to the knowledge may be processed, so that the corpus data may be converted into the structured data and stored in the knowledge database. On the one hand, the unified management and representation of the knowledge data may be realized, and on the other hand, it is convenient to quickly retrieve and recall the knowledge, so as to support the large language model to quickly respond to the user and improve the user experience.

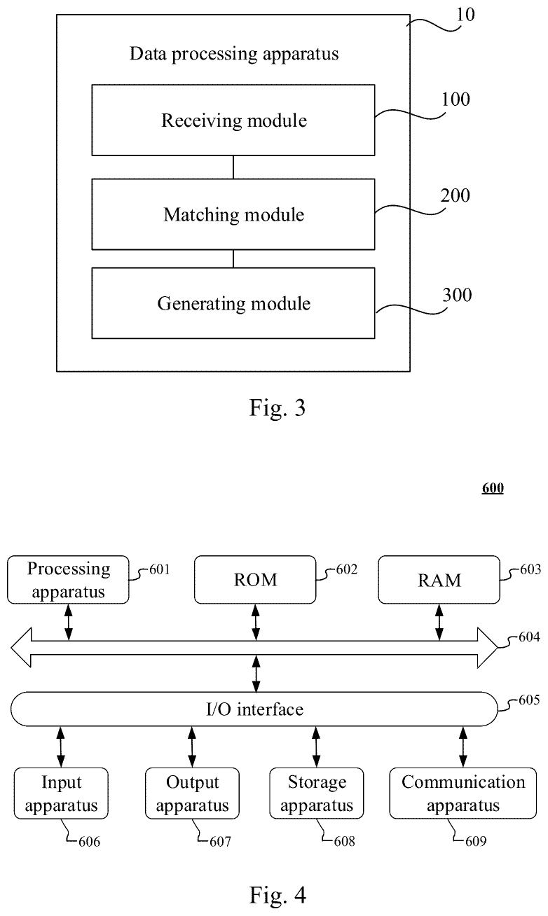

Based on the same inventive concept, the present disclosure further provides a data processing apparatus. As shown in FIG. 3, the apparatus 10 includes:
a receiving module 100, configured to receive retrieval data;
a matching module 200, configured to match the retrieval data with structured data in a knowledge database to obtain candidate question data and candidate answer data, where knowledge in the knowledge database is represented by the structured data, and each piece of the structured data includes one piece of answer data and at least one piece of question data corresponding to the answer data; and
a generating module 300, configured to generate a target retrieval result corresponding to the retrieval data according to the candidate question data and the candidate answer data.

Optionally, the matching module includes:
a first processing sub-module, configured to preprocess the retrieval data to obtain processed retrieval data; and
a matching sub-module, configured to match the processed retrieval data with question data in the structured data, use the matched question data as the candidate question data, and use answer data corresponding to the candidate question data as the candidate answer data.

Optionally, the generating module includes:
a first obtaining sub-module, configured to obtain a matching degree between each piece of the candidate question data and the retrieval data; and
a first determining sub-module, configured to determine the candidate answer data corresponding to the candidate question data with the highest matching degree as the target retrieval result if there is a matching degree greater than a preset threshold.

Optionally, the generating module includes:
a first obtaining sub-module, configured to obtain a matching degree between each piece of the candidate question data and the retrieval data; and
a second determining sub-module, configured to construct a prompt text according to the candidate question data, the candidate answer data, and the retrieval data to generate the target retrieval result based on the prompt text and the retrieval model if there is no matching degree greater than a preset threshold.

Optionally, the determination of the structured data in the knowledge database is generated by a determining module, and the determining module includes:
a second obtaining sub-module, configured to obtain corpus data corresponding to the knowledge;
a second processing sub-module, configured to process the corpus data to obtain a processed text corresponding to the corpus data;
a first generating sub-module, configured to generate at least one piece of processed structured data corresponding to the processed text based on the processed text, where the processed structured data includes one piece of processed answer data and at least one piece of processed question data corresponding to the processed answer data;
a third processing sub-module, configured to verify the processed structured data to determine the target structured data; and
a first updating sub-module, configured to update the structured data in the knowledge database based on the target structured data.

Optionally, the third processing sub-module includes:
a third determining sub-module, configured to determine whether the processed question data and the processed answer data in the processed structured data match for each piece of the processed structured data; and
a verifying sub-module, configured to verify the processed structured data based on a matched result and a verification condition to obtain the target structured data.

The verification condition includes: if the processed question data and the processed answer data do not match, deleting the processed question data; and if there is no processed question data matching the processed answer data in the processed structured data, deleting the processed structured data.

Optionally, the third processing sub-module includes:
a displaying sub-module, configured to display the processed structured data; and
a second updating sub-module, configured to update the processed question data in the processed structured data with the question data obtained after the update operation to obtain the target structured data in response to receiving the update operation of the user on the processed question data in the processed structured data.

Optionally, the first updating sub-module includes:
a fourth determining sub-module, configured to determine whether there is second question data matching first question data in the target structured data in the structured data stored in the knowledge database;
a first storing sub-module, configured to store the target structured data in the knowledge database if there is no second question data;
a fifth determining sub-module, configured to generate updated answer data corresponding to the second question data based on first answer data in the target structured data and second answer data corresponding to the second question data if there is the second question data; and a second storing sub-module, configured to generate updated target structured data according to the first question data, the second question data, and the updated answer data, and store the updated target structured data in the knowledge database.

Reference is made to FIG. 4 below, which illustrates a schematic structural diagram of an electronic device 600 (such as a terminal device or a server) suitable for implementing the embodiments of the present disclosure. The terminal device in the embodiments of the present disclosure may include, but is not limited to, mobile terminals such as a mobile phone, a laptop, a digital broadcast receiver, a personal digital assistant (PDA), a tablet computer, a portable multimedia player (PMP), a vehicle-mounted terminal (such as a vehicle navigation terminal) and the like, and fixed terminals such as a digital TV, a desktop computer and the like. The electronic device shown in FIG. 4 is only an example, and should not bring any limitation to the function and use scope of the embodiments of the present disclosure.

As shown in FIG. 4, the electronic device 600 may include a processing apparatus 601 (such as a central processing unit, a graphics processor, etc.), which may perform various appropriate actions and processing according to a program stored in a read-only memory (ROM) 602 or a program loaded from a storage apparatus 608 into a random access memory (RAM) 603. The RAM 603 further stores various programs and data required for the operation of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, a gyroscope, etc.; an output apparatus 607 including, for example, a liquid crystal display (LCD), a speaker, a vibrator, etc.; a storage apparatus 608 including, for example, a magnetic tape, a hard disk, etc.; and a communication apparatus 609. The communication apparatus 609 may allow the electronic device 600 to perform wireless or wired communication with other devices to exchange data. Although FIG. 4 shows the electronic device 600 having various apparatuses, it should be understood that not all the illustrated apparatuses are required to be implemented or provided. Alternatively, more or fewer apparatuses may be implemented or provided.

In particular, according to the embodiments of the present disclosure, the process described above with reference to the flowchart may be implemented as a computer software program. For example, an embodiment of the present disclosure includes a computer program product, which includes a computer program carried on a non-transitory computer-readable medium, and the computer program includes program codes for executing the method shown in the flowchart. In such an embodiment, the computer program may be downloaded and installed from the network through the communication apparatus 609, or installed from the storage apparatus 608, or installed from the ROM 602. When the computer program is executed by the processing apparatus 601, the above functions defined in the method of the embodiments of the present disclosure are executed.

It should be noted that the above computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, a computer-readable storage medium may be any tangible medium that contains or stores a program, and the program may be used by or in combination with an instruction execution system, apparatus, or device. In the present disclosure, a computer-readable signal medium may include a data signal propagated in a baseband or as a part of a carrier, in which computer-readable program codes are carried. The data signal propagated in this manner may take a variety of forms, including but not limited to an electromagnetic signal, an optical signal, or any suitable combination thereof. The computer-readable signal medium may also be any computer-readable medium other than the computer-readable storage medium. The computer-readable signal medium may send, propagate, or transmit a program used by or in combination with an instruction execution system, apparatus, or device. The program codes contained in the computer-readable medium may be transmitted by any suitable medium, including but not limited to an electric wire, an optical cable, radio frequency (RF), or any suitable combination thereof.

In some implementations, the client and the server may communicate using any currently known or future developed network protocol such as the HyperText Transfer Protocol (HTTP), and may be interconnected with any form or medium of digital data communication (for example, a communication network). Examples of the communication network include a local area network (“LAN”), a wide area network (“WAN”), an internetwork (for example, the Internet), and a peer-to-peer network (for example, an ad hoc peer-to-peer network), as well as any currently known or future developed network.

The above computer-readable medium may be included in the above electronic device, or may exist alone without being assembled into the electronic device.

The above computer-readable medium carries one or more programs, and when the one or more programs are executed by the electronic device, the electronic device is caused to: receive retrieval data; match the retrieval data with structured data in a knowledge database to obtain candidate question data and candidate answer data, where knowledge in the knowledge database is represented by the structured data, and each piece of the structured data includes one piece of answer data and at least one piece of question data corresponding to the answer data; and generate a target retrieval result corresponding to the retrieval data according to the candidate question data and the candidate answer data.

The computer program codes for executing the operations of the present disclosure may be written in one or more programming languages or a combination thereof. The above programming languages include but are not limited to object-oriented programming languages such as Java, Smalltalk, C++, and also include conventional procedural programming languages such as “C” or similar programming languages. The program codes may be executed entirely on a user's computer, executed partly on a user's computer, executed as a stand-alone software package, executed partly on a user's computer and partly on a remote computer, or executed entirely on a remote computer or a server. In the case of involving the remote computer, the remote computer may be connected to the user's computer through any type of network, including a local area network (LAN) or a wide area network (WAN), or may be connected to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a part of codes that includes one or more executable instructions for implementing specified logical functions. It should also be noted that, in some alternative implementations, the functions marked in the blocks may also occur in an order different from those marked in the drawings. For example, two blocks shown in succession may, in fact, be executed substantially concurrently, or the two blocks may sometimes be executed in a reverse order, depending upon the functionality involved. It should also be noted that each block of the block diagrams and/or flowcharts, and combinations of blocks in the block diagrams and/or flowcharts, may be implemented by a dedicated hardware-based system that performs the specified functions or operations, or may be implemented by a combination of dedicated hardware and computer instructions.

The modules involved in the embodiments of the present disclosure may be implemented in software or hardware. The name of the module does not constitute a limitation to the module itself under certain circumstances. For example, the receiving module may also be described as “a module for receiving retrieval data”.

The functions described above herein may be performed, at least in part, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium may include an electrical connection with one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

According to one or more embodiments of the present disclosure, Example 1 provides a data processing method, where the method includes: receiving retrieval data; matching the retrieval data with structured data in a knowledge database to obtain candidate question data and candidate answer data, where knowledge in the knowledge database is represented by the structured data, and each piece of the structured data includes one piece of answer data and at least one piece of question data corresponding to the answer data; and generating a target retrieval result corresponding to the retrieval data according to the candidate question data and the candidate answer data.

According to one or more embodiments of the present disclosure, Example 2 provides the method of Example 1, where the step in which the retrieval data is matched with the structured data in the knowledge database to obtain the candidate question data and the candidate answer data includes: preprocessing the retrieval data to obtain processed retrieval data; and matching the processed retrieval data with question data in the structured data, using the matched question data as the candidate question data, and using answer data corresponding to the candidate question data as the candidate answer data.

According to one or more embodiments of the present disclosure, Example 3 provides the method of Example 1, where the step in which the target retrieval result corresponding to the retrieval data is generated according to the candidate question data and the candidate answer data includes: obtaining a matching degree between each piece of the candidate question data and the retrieval data; and determining the candidate answer data corresponding to the candidate question data with the highest matching degree as the target retrieval result if there is a matching degree greater than a preset threshold.

According to one or more embodiments of the present disclosure, Example 4 provides the method of Example 1, where the step in which the target retrieval result corresponding to the retrieval data is generated according to the candidate question data and the candidate answer data includes: obtaining a matching degree between each piece of the candidate question data and the retrieval data; and constructing a prompt text according to the candidate question data, the candidate answer data, and the retrieval data to generate the target retrieval result based on the prompt text and the retrieval model if there is no matching degree greater than a preset threshold.

According to one or more embodiments of the present disclosure, Example 5 provides the method of Example 1, where the determining way of the structured data in the knowledge database includes: obtaining corpus data corresponding to the knowledge;
processing the corpus data to obtain a processed text corresponding to the corpus data;
generating at least one piece of processed structured data corresponding to the processed text based on the processed text, where the processed structured data includes one piece of processed answer data and at least one piece of processed question data corresponding to the processed answer data;
verifying the processed structured data to determine the target structured data; and updating the structured data in the knowledge database based on the target structured data.

According to one or more embodiments of the present disclosure, Example 6 provides the method of Example 5, where the step in which the processed structured data is verified to determine the target structured data includes: determining whether the processed question data and the processed answer data in the processed structured data match for each piece of the processed structured data; and verifying the processed structured data based on the matched result and the verification condition to obtain the target structured data.

The verification condition includes: if the processed question data and the processed answer data do not match, deleting the processed question data; and if there is no processed question data matching the processed answer data in the processed structured data, deleting the processed structured data.

According to one or more embodiments of the present disclosure, Example 7 provides the method of Example 5, where the step in which the processed structured data is verified to determine the target structured data includes: displaying the processed structured data; and updating the processed question data in the processed structured data with the question data obtained after the update operation to obtain the target structured data in response to receiving the update operation of the user on the processed question data in the processed structured data.

According to one or more embodiments of the present disclosure, Example 8 provides the method of Example 5, where the step in which the structured data in the knowledge database is updated based on the target structured data includes:
determining whether there is second question data matching first question data in the target structured data in the structured data stored in the knowledge database;
storing the target structured data in the knowledge database if there is no second question data;
generating updated answer data corresponding to the second question data based on first answer data in the target structured data and second answer data corresponding to the second question data if there is the second question data; and
generating updated target structured data according to the first question data, the second question data, and the updated answer data, and storing the updated target structured data in the knowledge database.

According to one or more embodiments of the present disclosure, Example 9 provides a data processing apparatus, the apparatus includes:
a receiving module, configured to receive retrieval data;
a matching module, configured to match the retrieval data with structured data in a knowledge database to obtain candidate question data and candidate answer data, where knowledge in the knowledge database is represented by the structured data, and each piece of the structured data includes one piece of answer data and at least one piece of question data corresponding to the answer data; and
a generating module, configured to generate a target retrieval result corresponding to the retrieval data according to the candidate question data and the candidate answer data.

According to one or more embodiments of the present disclosure, Example 10 provides a computer-readable medium, on which a computer program is stored, and when the computer program is executed by a processing apparatus, the steps of the method according to any of Examples 1-8 are implemented.

According to one or more embodiments of the present disclosure, Example 11 provides an electronic device, including: a storage apparatus, on which a computer program is stored; and a processing apparatus, configured to execute the computer program in the storage apparatus to implement the steps of the method according to any of Examples 1-8.

According to one or more embodiments of the present disclosure, Example 12 provides a computer program product, including a computer program, and when the computer program is executed by a processor, the steps of the method according to any of Examples 1-8 are implemented.

The above description is only preferred embodiments of the present disclosure and an explanation of the applied technical principles. Those skilled in the art should understand that the scope of disclosure involved in the present disclosure is not limited to the technical solution formed by the specific combination of the above technical features, but also covers other technical solutions formed by any combination of the above technical features or their equivalent features without departing from the above disclosed concept. For example, the technical solution formed by replacing the above features with the technical features with similar functions disclosed in the present disclosure (but not limited to).

In addition, although operations are described in a particular order, this should not be understood as requiring that these operations be performed in the specific order shown or in a sequential order. Under certain circumstances, multitasking and parallel processing may be advantageous. Similarly, although the above discussion contains several specific implementation details, these should not be interpreted as limiting the scope of the present disclosure. Certain features that are described in the context of separate embodiments may also be implemented in combination in a single embodiment. Conversely, various features described in the context of a single embodiment may also be implemented in multiple embodiments individually or in any suitable sub-combination.

Although the subject matter has been described in language specific to structural features and/or method logical actions, it should be understood that the subject matter defined in the appended claims is not necessarily limited to the specific features or actions described above. On the contrary, the specific features and actions described above are merely exemplary forms of implementing the claims. Regarding the apparatus in the above embodiments, the specific manners in which the respective modules perform operations have been described in detail in the embodiments related to the method, and will not be described in detail here.

1. A data processing method, comprising:
receiving retrieval data;
matching the retrieval data with structured data in a knowledge database to obtain candidate question data and candidate answer data, wherein knowledge in the knowledge database is represented by the structured data, and each piece of the structured data comprises one piece of answer data and at least one piece of question data corresponding to the answer data; and
generating a target retrieval result corresponding to the retrieval data according to the candidate question data and the candidate answer data.

2. The method according to claim 1, wherein the matching the retrieval data with the structured data in the knowledge database to obtain the candidate question data and the candidate answer data comprises:
preprocessing the retrieval data to obtain processed retrieval data;
matching the processed retrieval data with the at least one piece of question data in the structured data, using the matched question data as the candidate question data, and using answer data corresponding to the candidate question data as the candidate answer data.

3. The method according to claim 1, wherein the generating the target retrieval result corresponding to the retrieval data according to the candidate question data and the candidate answer data comprises:
obtaining a matching degree between each piece of the candidate question data and the retrieval data; and
determining, in response to there being a matching degree greater than a preset threshold, candidate answer data corresponding to candidate question data with a highest matching degree as the target retrieval result.

4. The method according to claim 1, wherein the generating the target retrieval result corresponding to the retrieval data according to the candidate question data and the candidate answer data comprises:
obtaining a matching degree between each piece of the candidate question data and the retrieval data; and
constructing, in response to there being no matching degree greater than a preset threshold, a prompt text according to the candidate question data, the candidate answer data, and the retrieval data, to generate the target retrieval result based on the prompt text and a retrieval model.

5. The method according to claim 1, wherein the structured data in the knowledge database is determined by:
obtaining corpus data corresponding to knowledge;
processing the corpus data to obtain a processed text corresponding to the corpus data;
generating at least one piece of processed structured data corresponding to the processed text based on the processed text, wherein the processed structured data comprises one piece of processed answer data and at least one piece of processed question data corresponding to the processed answer data;
verifying the processed structured data to determine target structured data; and
updating the structured data in the knowledge database based on the target structured data.

6. The method according to claim 5, wherein the verifying the processed structured data to determine the target structured data comprises:
determining, for each piece of the processed structured data, whether the processed question data matches the processed answer data in the processed structured data; and
verifying the processed structured data based on the matched result and a verification condition to obtain the target structured data;
wherein the verification condition comprises:
deleting, when the processed question data does not match the processed answer data, the processed question data; and
deleting, when there is no processed question data matching the processed answer data in the processed structured data, the processed structured data.

7. The method according to claim 5, wherein the verifying the processed structured data to determine the target structured data comprises:
displaying the processed structured data; and
updating, in response to receiving an update operation of a user on the processed question data in the processed structured data, the processed question data in the processed structured data with question data obtained after the update operation to obtain the target structured data.

8. The method according to claim 5, wherein the updating the structured data in the knowledge database based on the target structured data comprises:
determining whether there is second question data matching first question data in the target structured data in the structured data stored in the knowledge database;
storing, in response to there being no second question data, the target structured data in the knowledge database;
generating, in response to there being the second question data, updated answer data corresponding to the second question data based on first answer data in the target structured data and second answer data corresponding to the second question data; and
generating updated target structured data according to the first question data, the second question data, and the updated answer data, and storing the updated target structured data in the knowledge database.

9. A non-transitory computer-readable storage medium, on which a computer program is stored, wherein when the computer program is executed by a processing apparatus, implements steps of a data processing method, the method comprising:
receiving retrieval data;
matching the retrieval data with structured data in a knowledge database to obtain candidate question data and candidate answer data, wherein knowledge in the knowledge database is represented by the structured data, and each piece of the structured data comprises one piece of answer data and at least one piece of question data corresponding to the answer data; and
generating a target retrieval result corresponding to the retrieval data according to the candidate question data and the candidate answer data.

10. The storage medium according to claim 9, wherein the matching the retrieval data with the structured data in the knowledge database to obtain the candidate question data and the candidate answer data comprises:
preprocessing the retrieval data to obtain processed retrieval data;
matching the processed retrieval data with the at least one piece of question data in the structured data, using the matched question data as the candidate question data, and using answer data corresponding to the candidate question data as the candidate answer data.

11. The storage medium according to claim 9, wherein the generating the target retrieval result corresponding to the retrieval data according to the candidate question data and the candidate answer data comprises:
obtaining a matching degree between each piece of the candidate question data and the retrieval data; and
determining, in response to there being a matching degree greater than a preset threshold, candidate answer data corresponding to candidate question data with a highest matching degree as the target retrieval result.

12. The storage medium according to claim 9, wherein the generating the target retrieval result corresponding to the retrieval data according to the candidate question data and the candidate answer data comprises:
obtaining a matching degree between each piece of the candidate question data and the retrieval data; and
constructing, in response to there being no matching degree greater than a preset threshold, a prompt text according to the candidate question data, the candidate answer data, and the retrieval data, to generate the target retrieval result based on the prompt text and a retrieval model.

13. The storage medium according to claim 9, wherein the structured data in the knowledge database is determined by:
obtaining corpus data corresponding to knowledge;
processing the corpus data to obtain a processed text corresponding to the corpus data;
generating at least one piece of processed structured data corresponding to the processed text based on the processed text, wherein the processed structured data comprises one piece of processed answer data and at least one piece of processed question data corresponding to the processed answer data;
verifying the processed structured data to determine target structured data; and
updating the structured data in the knowledge database based on the target structured data.

14. The storage medium according to claim 13, wherein the verifying the processed structured data to determine the target structured data comprises:
determining, for each piece of the processed structured data, whether the processed question data matches the processed answer data in the processed structured data; and
verifying the processed structured data based on the matched result and a verification condition to obtain the target structured data;
wherein the verification condition comprises:
deleting, when the processed question data does not match the processed answer data, the processed question data; and
deleting, when there is no processed question data matching the processed answer data in the processed structured data, the processed structured data.

15. The storage medium according to claim 13, wherein the verifying the processed structured data to determine the target structured data comprises:
displaying the processed structured data; and
updating, in response to receiving an update operation of a user on the processed question data in the processed structured data, the processed question data in the processed structured data with question data obtained after the update operation to obtain the target structured data.

16. The storage medium according to claim 13, wherein the updating the structured data in the knowledge database based on the target structured data comprises:
determining whether there is second question data matching first question data in the target structured data in the structured data stored in the knowledge database;
storing, in response to there being no second question data, the target structured data in the knowledge database;
generating, in response to there being the second question data, updated answer data corresponding to the second question data based on first answer data in the target structured data and second answer data corresponding to the second question data; and
generating updated target structured data according to the first question data, the second question data, and the updated answer data, and storing the updated target structured data in the knowledge database.

17. An electronic device, comprising:
a storage apparatus, on which a computer program is stored; and
a processing apparatus, configured to execute the computer program in the storage apparatus to implement steps of a data processing method, the method comprising:
receiving retrieval data;
matching the retrieval data with structured data in a knowledge database to obtain candidate question data and candidate answer data, wherein knowledge in the knowledge database is represented by the structured data, and each piece of the structured data comprises one piece of answer data and at least one piece of question data corresponding to the answer data; and
generating a target retrieval result corresponding to the retrieval data according to the candidate question data and the candidate answer data.

18. The electronic device according to claim 17, wherein the matching the retrieval data with the structured data in the knowledge database to obtain the candidate question data and the candidate answer data comprises:
preprocessing the retrieval data to obtain processed retrieval data;
matching the processed retrieval data with the at least one piece of question data in the structured data, using the matched question data as the candidate question data, and using answer data corresponding to the candidate question data as the candidate answer data.

19. The electronic device according to claim 17, wherein the generating the target retrieval result corresponding to the retrieval data according to the candidate question data and the candidate answer data comprises:
obtaining a matching degree between each piece of the candidate question data and the retrieval data; and
determining, in response to there being a matching degree greater than a preset threshold, candidate answer data corresponding to candidate question data with a highest matching degree as the target retrieval result.

20. The electronic device according to claim 17, wherein the generating the target retrieval result corresponding to the retrieval data according to the candidate question data and the candidate answer data comprises:
obtaining a matching degree between each piece of the candidate question data and the retrieval data; and
constructing, in response to there being no matching degree greater than a preset threshold, a prompt text according to the candidate question data, the candidate answer data, and the retrieval data, to generate the target retrieval result based on the prompt text and a retrieval model.
